(19) United States
(12) Patent Application Publication
(10) Pub. No.: US 2021/0029988 A1
(43) Pub. Date: Feb. 4, 2021

(54) PEST REPELLENT COMPOSITION

(71) Applicant: JGC CATALYSTS AND CHEMICALS LTD., Kanagawa (JP)

(72) Inventors: Satoshi WATANABE, Kitakyushu-shi, Fukuoka (JP); Naoyuki ENOMOTO, Kitakyushu-shi, Fukuoka (JP)

(21) Appl. No.: 16/982,366

(22) PCT Filed: Mar. 28, 2019
(86) PCT No.: PCT/JP2019/013870

§ 371 Date: Sep. 18, 2020

(30) Foreign Application Priority Data
Mar. 29, 2018 (JP) 2018-065442

(51) Int. Cl. A01N 25/04; A01N 25/18; A01N 37/18

(52) U.S. Cl. CPC A01N 25/04; A01N 37/18; A01N 25/18

(57) ABSTRACT

There is provided a pest repellent composition which enables stable repellent effects to persist for an extended period. The pest repellent composition includes a pest repellent component, a solvent, and a porous particle. The porous particle is formed with primary particles aggregated to define pores. The primary particle contains silica component. In an infrared absorption spectrum of the porous particle, a ratio (I₁/I₂) between a maximum absorbance I₁ at 3730 to 3750 cm⁻¹ and a maximum absorbance I₂ at 1160 to 1260 cm⁻¹ is 0.005 or less. Furthermore, the porous particle preferably has a pore volume PV ranging from more than 1.0 to 5.0 mL/g and an average pore diameter PD ranging from 0.005 to 0.5 μm.

### TECHNICAL FIELD

The present invention relates to a pest repellent composition including a pest repellent component, a solvent, and a porous particle. In particular, the present invention relates to a pest repellent composition that strikes a balance between the suppression of transdermal absorption and the stabilization of volatilization of the pest repellent component.

### BACKGROUND ART

For protecting the human body from pests such as mosquitoes, gnats, horseflies, fleas, tropical rat mites, stable flies, bedbugs, or mites, an insect repellent formulation containing a pest repellent component is used. Also, regarding pest repellent components (such as DEET and picaridin) that are permitted to be applied on the skin, stimuli to the skin needs to be reduced. For example, it is reported that about 50% of DEET applied on the skin is transdermally absorbed within 6 hours. That is, the suppression of transdermal absorption can enhance the persistence of pest repellent effects. At the same time, stimuli to the skin can be reduced.

Under such circumstances, there is known a pest repellent composition including a pest repellent component, an anhydrous silicic acid, a propellant, and a solvent (for example, see PATENT LITERATURE 1). According to this composition, the pest repellent component is incorporated into pores of the anhydrous silicic acid. Therefore, volatilization of the pest repellent component can be prevented. Also, a direct contact area between the pest repellent component and the skin decreases. This can reduce the stimuli to the skin. At the same time, stickiness can be reduced.

There is also known a pest repellent composition including a pest repellent component with which micropores or pores of a porous organic powder are impregnated (for example, see PATENT LITERATURE 2).

### CITATION LIST

### Patent Literature

PATENT LITERATURE 1: JP-A-9-208406

PATENT LITERATURE 2: JP-A-6-271402

### SUMMARY OF THE INVENTION

### Problems to be Solved by the Invention

PATENT LITERATURE 1 describes that the pest repellent component is incorporated into pores of the anhydrous silicic acid. However, in an anhydrous silicic acid having a pore volume of 1 mL/g or less, the amount of the pest repellent component to be incorporated is small. Therefore, the volatilization of the pest repellent component and the stickiness of the pest repellent composition were not sufficiently prevented.

Also, the aerosol agent of PATENT LITERATURE 2 includes a porous organic powder containing a pest repellent component with which pores are impregnated. However, an aerosol agent often contains, as a diluent, a solvent such as ethanol in which a pest repellent component can be dissolved. In this case, a mixed solution of the pest repellent component and the solvent is contained in the porous organic powder. Accordingly, an excess pest repellent component, which cannot be housed in pores, is applied as a liquid phase on the skin. Therefore, the effect of reducing stickiness and the effect of decreasing the vaporization of a pest repellent component could not be sufficiently obtained. Also, some of pest repellent components, such as DEET, have a strong effect of dissolving a plastic product therein. Therefore, when the pest repellent component existing as a liquid phase on the skin contacts a plastic product, the plastic product sometimes deteriorated or had visual failures.

### Solutions to the Problems

Therefore, the pest repellent composition of the present invention includes a porous particle containing silica-containing primary particles aggregated to form a pore, a pest repellent component, and a solvent. A ratio (I₁/I₂) between a maximum absorbance (I₁) at 3730 to 3750 cm⁻¹ and a maximum absorbance (I₂) at 1160 to 1260 cm⁻¹ in an infrared absorption spectrum of the porous particle is 0.005 or less.

According to such a pest repellent composition, the pest repellent component applied on the skin is efficiently absorbed by the pore of the porous particle. Therefore, the pest repellent component to contact the skin can be reduced. Accordingly, transdermal absorption is suppressed.

The pest repellent component volatilizes, in response to a vapor pressure, from the porous particle which has absorbed the pest repellent component. Therefore, pest repellent effects are persistently expressed. However, when the particle absorbs moisture (when moisture adheres to the surface of the particle), the volatilization of the pest repellent component is inhibited. Therefore, the adherence of moisture to the particle surface needs to be prevented so that stable volatilization persists for an extended period. The absorbance ratio (I₁/I₂) of the porous particle is 0.005 or less. Therefore, the particle surface has low hydrophilicity. Accordingly, adsorption of moisture can be prevented.

Furthermore, a pore volume (PV) of the porous particle is set to a range from more than 1.0 to 5.0 mL/g. Also, an average pore diameter (PD) is set to a range from 0.005 to 0.5 μm.

Also, for uniformizing the volatilization speed of the pest repellent component, the moisture absorption rate of the porous particle is set to 10% or less. Also, the opening rate of the pore is set to 20 to 75%. Furthermore, a ratio (PD/VP) between an average pore diameter PD [μm] of the porous particle and a vapor pressure VP [Pa] at 20° C. of the pest repellent component is set to 500 or less.

### Effects of the Invention

According to the pest repellent composition of the present invention, the pest repellent component applied on the skin is efficiently absorbed by the pore of the porous particle. Therefore, the pest repellent component to contact the skin can be reduced. Accordingly, transdermal absorption is suppressed. Furthermore, the surface of the porous particle has low hydrophilicity. Therefore, volatilization of the pest repellent component is not inhibited by moisture absorption. Thus, stable repellent effects can persist for an extended period.

### DESCRIPTION OF EMBODIMENTS

A pest repellent composition of the present invention includes a porous particle, a pest repellent component, and a solvent. The porous particle is formed with aggregated primary particles each containing a silica component. This porous particle has a pore constituted by a gap among the primary particles. This porous particle is measured by an infrared absorption spectrum to obtain a maximum absorbance (I₁) at 3730 to 3750 cm⁻¹ and a maximum absorbance (I₂) at 1160 to 1260 cm⁻¹. An absorbance ratio (I₁/I₂) is 0.005 or less. When such a pest repellent composition is applied on the skin, the pest repellent component is efficiently absorbed on the skin by the pore of the porous particle. Therefore, the pest repellent component to contact the skin decreases. This suppresses transdermal absorption and adverse effects on a plastic product. Furthermore, the absorbance ratio (I₁/I₂) of the porous particle is 0.005 or less. Therefore, the particle surface has low hydrophilicity. Accordingly, moisture is unlikely to adsorb to the particle. As a result, vaporization of the pest repellent component is not inhibited. In this manner, a balance can be struck between the suppression of transdermal absorption and the stabilization of volatilization of the pest repellent component. Thus, pest repellent effects are persistently expressed in a stable manner even for an extended period.

Here, the absorbance ratio (I₁/I₂) depends on the amount of a silanol group on the particle surface. When a silanol group (Si—OH) on the particle surface decreases, the infrared absorbance at 3730 to 3750 cm⁻¹ decreases. On the other hand, the infrared absorbance at 1160 to 1260 cm⁻¹ which belongs to a siloxane bond (Si—O—Si) increases. A silanol group combines with water. Therefore, the smaller the number of silanol groups, the lower the hydrophilicity That is, it can be said that the smaller the absorbance ratio (I₁/I₂), the lower the hydrophilicity on the surface of the particle. For reducing the absorbance ratio, a surface treatment with a silane compound or the like, firing at a high temperature, or the like can be performed. This can reduce a silanol group to hydrophobize the surface.

For this surface treatment, a low molecular weight silane compound having a molecular weight of 500 or less is preferably used. Hydrophobicity can also be obtained by a high molecular weight silane compound combined with a silanol group. However, a high molecular weight silane compound has a large molecule. Therefore, a high molecular weight silane compound inhibits molecules of other silane compounds from combining with adjacent silanol groups. As a result, there is a risk that a large number of uncombined silanol groups may remain (steric hindrance). The remaining silanol groups can form a local minimum hydrophilic phase. Therefore, it is preferable to use a low molecular weight silane compound for reducing the uncombined silanol groups. Furthermore, a small-sized low molecular weight compound easily combines with a silanol group in the pore. Therefore, a low molecular weight compound can also provide hydrophobicity on the surface inside the pore.

The pore volume of such a porous particle is preferably more than 1.0 mL/g and not more than 5.0 mL/g. When the pore volume is large, the pest repellent component can be contained in a large amount. Therefore, repellent effects persist. Also, the pest repellent component is held in a gap (pore) inside the porous particle. Accordingly, the repellent component does not directly contact the skin. Therefore, transdermal absorption is suppressed. Thus, repellent effects can be exerted for an extended period.

Also, the average pore diameter (PD) of the porous particle is preferably in a range from 0.005 to 0.5 μm. A small pore diameter sometimes suppresses the volatilization of the pest repellent component. In this case, repellent effects themselves are lowered. Also, an excessively large pore diameter sometimes promotes the volatilization of the pest repellent component. In this case, the persistence of repellent effects decreases. A particularly preferable range is from more than 0.010 to 0.4 μm.

Also, the moisture absorption rate of the porous particle left to stand for 24 hours under the conditions of a temperature of 80° C. and a relative humidity of 80% is preferably 10% or less. Such a porous particle having a low moisture absorption rate does not inhibit the volatilization of the pest repellent component as previously described. Therefore, stable repellent effects can be obtained. This moisture absorption rate is more preferably 5% or less, and further preferably 1% or less.

Such a porous particle is hydrophobic and has a contact angle to water of more than 90°. However, the contact angle to the repellent component is in a range from 1° to 90°. Therefore, the porous particle does not absorb moisture. Accordingly, volatilization of the repellent component is not inhibited. As a result, stable repellent effects can be exerted.

Also, the opening rate and the average pore diameter of the pore in the porous particle can be adjusted depending on the vapor pressure of the pest repellent component. Accordingly, the volatilization speed of the pest repellent component can be controlled. When the vapor pressure at 20° C. of the pest repellent component is V_{P} [Pa], the ratio (PD/VP) between the average pore diameter PD (μm) of the porous particle and the vapor pressure V_{P} [Pa] is preferably 500 or less. Within this range, rapid volatilization can be prevented. Therefore, persistent repellent effects can be obtained. Furthermore, volatilization of the pest repellent component is not inhibited. Also, the opening rate of the pore on the particle surface is preferably 20 to 75%. When the opening rate is less than 20%, vaporization of the pest repellent component is inhibited. As a result, stable repellent effects cannot be exerted. When the opening rate exceeds 75%, the strength of the porous particle decreases. Therefore, there is a risk that the particle may break during the process of mixing the particle to a formulation.

It is noted that a ratio (V_{PS}/V_{P}) between a vapor pressure V_{PS} [Pa] at 20° C. of the solvent of the main component and a vapor pressure V_{P} [Pa] at 20° C. of the pest repellent component contained in the pest repellent composition is suitably 1000 or more. Within this range, the composition applied on the skin forms a coat of a mixture of the solvent, the pest repellent component, and the porous particle, and thereafter the solvent immediately volatilizes. Therefore, a coat of the pest repellent component and the porous particle is formed. The solvent absorbed inside the porous particle also volatilizes. The resultant vacant pore absorbs the repellent component. For suppressing the transdermal absorption of the repellent component, a solvent capable of increasing the above-described vapor pressure ratio is desirably selected. This vapor pressure ratio is preferably 2000 or more, and further preferably 3000 or more.

The solvent to be used may be either a solvent in which the pest repellent component can be dissolved or a solvent in which the pest repellent component cannot be dissolved. In many cases, lower alcohols such as ethanol and modified ethanol are used.

Furthermore, the average particle diameter of the porous particle is suitably 0.5 to 20 μm. Within this range, dry touch can be obtained when applied. Also, the compression strength of the porous particle is preferably 0.1 to 100 KPa. When the repellent composition containing the porous particle is spread over the skin by hand, the porous particle breaks into primary particles, which adhere to the skin. Therefore, even when moisture such as sweat or rain exists, the repellent composition is unlikely to drop off the skin. Accordingly, repellent effects can persist. The average particle diameter of the primary particles is preferably 0.005 to 1.0 μm.

Also, the pest repellent composition preferably includes the porous particle in an amount of 1 to 30% by weight.

Here, the primary particle constituting the porous particle may contain, in addition to silica as a main component, alumina, zirconia, titania, or the like in an amount of 10 to 50% by mass. Considering that the porous particle is formulated into pharmaceuticals or quasi drugs, an amorphous silica particle is preferable as the primary particle.

It is noted that examples of the pest repellent component include, in addition to DEET (N,N-diethyl-m-toluamide) which is confirmed to be safe to the human body, icaridin and IR3535 (cetyl(butyl)aminopropanoate). Also, examples of a pest repellent extracted from a naturally occurring plant or the like include, in addition to an essential oil of lemon eucalyptus and PMD (p-menthane-3,8-diol) as an active compound thereof, camphor, castor oil, achillea oil, oregano oil, catnip oil, citronella oil, cinnamon oil, cinnamon leaf oil, cedar oil, geranium oil, celery extract, tea tree oil, clove oil, neem oil, garlic oil, hazelnut oil, basil oil, fennel oil, mentha herb oil, peppermint oil, marigold oil, lavender oil, lemongrass oil, rosemary oil, thyme oil, eucalyptus oil, and a mixture thereof.

The pest repellent composition of the present invention can be applied to any form of an aerosol, a lotion, a cream, and the like. When applied to an aerosol, liquefied petroleum gas such as LPG is added as a propellant. Also, a moisturizer, a dispersant, a flavor, a pigment, a refrigerant, a bactericide, a UV absorber, a UV scattering agent, or a lubricant is added as necessary.

Hereinafter, examples in which DEFT is used as the pest repellent component will be specifically described.

### Example 1

First, as a raw material particle, an SMB LB-1500 manufactured by JGC Catalysts and Chemicals Ltd. (average particle diameter 15 μm, pore volume 1.3 mL/g, pore diameter 12 nm, and oil adsorption 230 mL/g) was used. To 1.0 kg of this raw material particle, 0.1 kg of hexamethyldisilazane (manufactured by Shin-Etsu Chemical Co., Ltd.: SZ-31, molecular weight: 161.4) and 2.3 kg of methanol (guaranteed reagent) were added. This mixed liquid was mixed at room temperature for 5 hours using a rotary evaporator. Thereafter, the mixed liquid was heated at 120° C. for 16 hours. Accordingly, a porous particle which was surface-treated with a silane compound was obtained. The obtained porous particle has a small number of silanol groups on the surface. That is, this porous particle is hydrophobized. Next, to 1.0 kg of this porous particle, 8.5 kg of ethanol and 1.3 L of DEET (manufactured by Tokyo Chemical Industry Co., Ltd.) were added. This mixture was stirred in a closed container for 30 minutes. In this manner, a pest repellent composition containing a porous particle, a pest repellent component, and a solvent is obtained. This pest repellent composition contains 12% by weight of DEET, 79% by weight of ethanol, and 9% by weight of a porous particle. The porous particle and the pest repellent composition were measured as samples for the following physical properties. The results are illustrated in Tables 1 and 2.

### (1) Absorbance Ratio

An infrared absorption spectrum of the porous particle was measured using an FT-IR6300 (manufactured by Jasco Corporation). A graph illustrating a relationship between a wave number (cm⁻¹) and an absorbance calculated according to the Kubelka-Munk formula was prepared. From the obtained graph, a maximum absorbance (I₁) at 3730 to 3750 cm⁻¹ and a maximum absorbance (I₂) at 1160 to 1260 cm⁻¹ were read. Based on the read absorbances, an absorbance ratio (I₁/I₂) was calculated.

### (2) Contact Angle

One gram of the porous particle was dried at 200° C. Thereafter, the porous particle poured in a cell having a diameter of 1 cm and a height of 5 cm was pressed with a load of 50 kgf to prepare a molded product. The contact angle to a drop of water dropped on the surface of this molded product was measured. Similarly, the contact angle to the pest repellent component was measured with a drop of DEET dropped on the surface of the molded product.

### (3) Pore Volume (PV) and Average Pore Diameter (PD)

A powder in an amount of 10 g of the porous particle placed in a crucible was dried at 300° C. for 1 hour. Thereafter, the pore diameter distribution of the powder of the porous particle cooled to room temperature in a desiccator was measured by a mercury intrusion method using an automatic porosimeter (PoreMaster PM33GT manufactured by Quantachrome Instruments). Particularly, mercury was press-fitted at 1.5 MPa to 231 MPa. A pore diameter distribution is obtained from a relationship between the pressure and the pore diameter. According to this method, mercury is press-fitted into pores of about 7 nm to about 1000 Therefore, both a small diameter pore existing inside the porous particle and a gap among the porous particles are expressed in the pore diameter distribution. The size of the gap among the particles is roughly ⅕ to ½ of the average particle diameter of the porous particles. A portion dependent on the gap between the porous particles was removed to produce the pore diameter distribution dependent on the pore. Based on the pore diameter distribution, the pore volume and the average pore diameter were calculated.

### (4) Opening Rate of Pore

The opening rate of the pore is defined by (pore area/analysis region area). An SEM (scanning electron microscope) picture (magnification: 30000 times) of a group of the porous particles was taken. Using an SEM image analysis software (Scandium manufactured by Olympus Corporation), images of randomly selected 100 to 200 particles are analyzed. At this time, the photographing magnification may be changed corresponding to the particle diameter so that the particle surface is photographed on the entire photographed image.

Specifically, a secondary electron image (SEM picture) is acquired through a scanning electron microscope (JSM-6010LA manufactured by JEOL Ltd.). From this SEM picture, 100 to 200 particles are randomly selected. The image data (secondary electron image, jpg image) of the SEM picture is read by a “Scandium” image analysis software. A specific region on the image is selected as an analysis region (frame). This analysis region (frame) is binarized. Particularly, 153 is selected as the lower limit value of the RGB values, and 255 is selected as the upper limit value. Binarization is performed with these two thresholds. Pores in the binarized analysis region are detected. The analysis region area and the pore area of the detected pores are obtained. This procedure is repeated until 100 to 200 porous particles have been analyzed.

### (5) Average Particle Diameter

A particle size distribution of the porous particle was measured by laser diffractometry. A median value in this particle size distribution was defined as an average particle diameter. In the measurement of the particle size distribution by laser diffractometry, an LA-950v2 laser diffraction/scattering particle diameter distribution measuring apparatus (equipped with a dry unit, manufactured by Horiba, Ltd.) was used.

### (6) Moisture Absorption Rate

Five grams of a powder of the porous particle taken in a crucible (“powder weight”, and “crucible weight” weighed to the fourth decimal place) was left to stand in a constant temperature and humidity tank (IG420 manufactured by Yamato Scientific Co., Ltd.) set at a temperature of 80° C. and a relative humidity of 80% for 24 hours. A “total weight of the crucible and the powder” after left to stand was weighed to the fourth decimal place. From the total weight, a “powder weight after moisture absorption” was calculated. From the result, a “moisture absorption rate (%)” was calculated as “moisture absorption rate (%)”=(“powder weight after moisture absorption”/“powder weight”)×100−100.

### (7) Inclusion Rate of Pest Repellent Component

A ratio of the amount (mL) of the added pest repellent component to the powder weight (g) of the raw material particle used in Example is defined as an inclusion rate (mL/g) of the pest repellent component.

### (8) Decrease Proportion of Pest Repellent Component

The pest repellent composition was weighed in a glass petri dish (146Ø×28) such that the total of the pest repellent component and the porous particle became 1.0 g (V₁). A total weight (V₂) of the powder and the glass petri dish was recorded. This was left to stand in a constant temperature and humidity tank (IG420 manufactured by Yamato Scientific Co., Ltd.) at a temperature of 37° C. and a relative humidity of 50%. A total weight (V₃) was measured every 5 hours. According to the following equation, a decrease proportion (after 5 hours) of the pest repellent component was calculated. Similarly, a total weight was measured after 10 hours of the standing time. A decrease proportion (after 10 hours) of the pest repellent component was calculated. When the inclusion rate of the pest repellent component is P₁ (mL/g), and the specific gravity of the included pest repellent component is D₁ (g/mL), the decrease proportion (%) is represented by the following equation.

Decrease proportion (%)=(V₂−V₃)/(V₁×(P₁/(1+P₁)×D₁)×100

### (9) Stickiness of Pest Repellent Composition

The pest repellent composition was subjected to a sensory test by 20 specialized panelists. More specifically, the panelists were interviewed regarding stickiness during application on the skin. The results were evaluated in accordance with the following evaluation criteria. Here, the less the sensed stickiness, the better the evaluation.

### Evaluation Criteria

Very good

Good

Fair

Poor

Very poor

### Example 2

A porous particle was prepared by performing a hydrophobization treatment to a raw material particle with SMB_SP-1 (manufactured by JGC Catalysts and Chemicals Ltd.: average particle diameter 12 μm, pore volume 2.9 mL/g, pore diameter 100 nm, and oil adsorption 370 mL/g) in the same manner as in Example 1. To 0.5 kg of the prepared porous particle, 10.2 kg of ethanol and 1.5 L of DEET (manufactured by Tokyo Chemical Industry Co., Ltd.) were added. The mixture was stirred in a closed container for 30 minutes to obtain a pest repellent composition. This pest repellent composition includes 12% by weight of DEET, 84% by weight of ethanol, and 4% by weight of a porous particle. The physical properties of these samples were measured in the same manner as in Example 1.

### Example 3

A pest repellent composition was obtained using porous particles prepared by performing a hydrophobization treatment in the same manner as in Example 1, except that a particle having an average particle diameter of 10 μm, a pore volume of 1.3 mL/g, and a pore diameter of 5 nm was used as a raw material particle. The physical properties were measured in the same manner as in Example 1. The pest repellent composition according to the present example includes 12% by weight of DEET, 79% by weight of ethanol, and 9% by weight of a porous particle.

### Example 4

A porous particle was prepared by performing a hydrophobization treatment in the same manner as in Example 2. To 1.0 kg of this porous particle, 6.0 kg of ethanol and 3.0 L of DEET (manufactured by Tokyo Chemical Industry Co., Ltd.) were added. The mixture was stirred in a closed container for 30 minutes to obtain a pest repellent composition. This pest repellent composition includes 30% by weight of DEET, 60% by weight of ethanol, and 10% by weight of a porous particle. The physical properties of these samples were measured in the same manner as in Example 1.

### Comparative Example 1

To 1.0 kg of the same raw material particle as in Example 1 (manufactured by JGC Catalysts and Chemicals Ltd.: SMB LB-1500), 8.5 kg of ethanol and 1.3 L of DEET (manufactured by Tokyo Chemical Industry Co., Ltd.) were added. A pest repellent composition was prepared by stirring the mixture in a closed container for 30 minutes. That is, no hydrophobization treatment was performed on the raw material particle. The physical properties of these samples were measured in the same manner as in Example 1.

### Comparative Example 2

To 0.5 kg of the same raw material particle as in Example 2 (manufactured by JGC Catalysts and Chemicals Ltd.: SMB SP-1), 10.2 kg of ethanol and 1.5 L of DEET (manufactured by Tokyo Chemical Industry Co., Ltd.) were added. A pest repellent composition was prepared by stirring the mixture in a closed container for 30 minutes. That is, no hydrophobization treatment was performed on the raw material particle. The physical properties of these samples were measured in the same manner as in Example 1.

TABLE 11

| | | Example | Example | Example | Example | Comparative | Comparative |
|---|---|---|---|---|---|---|---|
| | | 1 | 2 | 3 | 4 | Example 1 | Example 2 |
| Porous | Absorbance ratio (I₁/I₂) | 0.001 | 0.001 | 0.001 | 0.001 | 0.015 | 0.015 |
| particle | Contact angle (to water) | 100° | 100° | 100° | 100° | 45° | 45° |
| | Contact angle (to pest repellent component) | 45° | 45° | 45° | 45° | 98° | 98° |
| | Average particle diameter [μm] | 15 | 12 | 10 | 12 | 15 | 12 |
| | Pore volume (PV) [mL/g] | 1.3 | 2.9 | 1.3 | 2.9 | 1.3 | 2.9 |
| | Average pore diameter (PD) [nm] | 12 | 100 | 5 | 100 | 12 | 100 |
| | Opening rate of pore [%] | 40 | 65 | 42 | 65 | 40 | 65 |
| | Moisture absorption rate [%] | 2 | 5 | 8 | 5 | 30 | 67 |
| Pest repellent | Pest repellent component | DEET | DEET | DEET | DEET | DEET | DEET |
| component | Vapor pressure at 20°C (VP) [Pa] | 0.22 | 0.22 | 0.22 | 0.22 | 0.22 | 0.22 |
| | PD/VP | 55 | 455 | 23 | 455 | 55 | 455 |
| Solvent | Type | Ethanol | Ethanol | Ethanol | Ethanol | Ethanol | Ethanol |
| | Vapor pressure at 20°C (VPₛ) [Pa] | 5886 | 5886 | 5886 | 5886 | 5886 | 5886 |

TABLE 2

| | | Example | Example | Example | Example | Comparative | Comparative |
|---|---|---|---|---|---|---|---|
| | | 1 | 2 | 3 | 4 | Example 1 | Example 2 |
| Inclusion rate of pest repellent component [mL/g] | | 1.3 | 3.0 | 1.3 | 3.0 | 1.3 | 3 |
| Decrease proportion [%] of | After 5 hours | 11 | 12 | 20 | 13 | 3 | 5 |
| pest repellent component | After 10 hours | 20 | 25 | 29 | 24 | 4 | 7 |

| | | | | | | |
|---|---|---|---|---|---|---|
| Formulation ratio (weight ratio) | 12:79:9 | 12:84:4 | 12:79:9 | 30:60:10 | 12:79:9 | 12:84:4 |
| DEET:ethanol:porous particle | | | | | | |
| Stickiness | Very good | Good | Fair | Good | Very poor | Very poor |

1. A pest repellent composition, comprising:
a pest repellent component;
a porous particle including silica component-containing primary particles aggregated to form a pore; and
a solvent,
wherein a ratio (I₁/I₂) between a maximum absorbance (I₁) at 3730 to 3750 cm⁻¹ and a maximum absorbance (I₂) at 1160 to 1260 cm⁻¹ in an infrared absorption spectrum of the porous particle is 0.005 or less.

2. The pest repellent composition according to claim 1,
wherein the porous particle has a pore volume (PV) of more than 1.0 to 5.0 mL/g and an average pore diameter (PD) of 0.005 to 0.5 μm.

3. The pest repellent composition according to claim 1,
wherein the porous particle has a moisture absorption rate of 10% or less when left to stand for 24 hours at a temperature of 80° C. and a relative humidity of 80%.

4. The pest repellent composition according to claim 1,
wherein the porous particle has an opening rate of 20 to 75% due to the pores on a surface of the porous particle.

5. The pest repellent composition according to claim 1,
wherein a ratio (PD/VP) between an average pore diameter PD [μm] and a vapor pressure VP [Pa] at 20° C. of the pest repellent component is 500 or less.

6. The pest repellent composition according to claim 1,
wherein the porous particle has a contact angle to water of more than 90° and a contact angle to the pest repellent component of 1° to 90°.

7. The pest repellent composition according to claim 1,
wherein a ratio (V_{PS}/V_{P}) between a vapor pressure V_{PS} [Pa] at 20° C. of a main component of the solvent and a vapor pressure V_{P} [Pa] at 20° C. of the pest repellent component is 1000 or more.
